(19) United States
(12) Patent Application Publication
(10) Pub. No.: US 2025/0330698 A1
(43) Pub. Date: Oct. 23, 2025

(54) IMAGE CAPTURING

(71) Applicant: Beijing Zitiao Network Technology Co., Ltd., Haidian District (CN)

(72) Inventors: Weiwei Yu, Beijing (CN); Xinyu Zhang, Beijing (CN)

(21) Appl. No.: 19/174,123

(22) Filed: Apr. 9, 2025

Related U.S. Application Data
(63) Continuation of application No. PCT/CN2024/089421, filed on Apr. 23, 2024.

(51) Int. Cl. H04N 23/63; H04N 23/667

(52) U.S. Cl. CPC H04N 23/632; H04N 23/633; H04N 23/667

(57) ABSTRACT

Provided in the disclosure a method, apparatus, device and storage medium for image capturing. The method comprises: displaying a capturing interface, the capturing interface comprising a preview component and a capturing control; in response to capturing a first image displayed in the preview component using the capturing control, storing the first image, and maintaining the display of a real-time captured image in the preview component; displaying a first element corresponding to the first image in a predetermined area of the capturing interface; and in response to capturing a second image displayed in the preview component using the capturing control, storing the second image, and displaying at least a portion of the first element and at least a portion of a second element corresponding to the second image in the predetermined area of the capturing interface.

### CROSS-REFERENCE

This application claims priority to PCT patent application PCT/CN2024/089421, entitled “Method for Image Capturing, apparatus, device and storage medium” filed on Apr. 23, 2024, the entire content of which are incorporated herein by reference.

### FIELD

Example embodiments of the present disclosure generally relate to the computer field, and more particularly, to image capturing.

### BACKGROUND

With the development of computer technology, people can use various electronic devices to capture images. For example, people can use applications to capture images and further edit the images to publish the corresponding works. In life, using electronic devices to capture images has become a routine task.

### SUMMARY

In a first aspect of the present disclosure, a method for image capturing is provided. The method includes: displaying a capturing interface, the capturing interface including a preview component and a capturing control; in response to capturing a first image displayed in the preview component using the capturing control, storing the first image, and maintaining the display of a real-time captured image in the preview component; displaying a first element corresponding to the first image in a predetermined area of the capturing interface; and in response to capturing a second image displayed in the preview component using the capturing control, storing the second image, and displaying at least a portion of the first element and at least a portion of a second element corresponding to the second image in the predetermined area of the capturing interface.

In a second aspect of the present disclosure, an apparatus for image capturing is provided. The apparatus includes: an interface display module configured to display a capturing interface, the capturing interface including a preview component and a capturing control; an image display module configured to, in response to capturing a first image displayed in the preview component using the capturing control, store the first image, and maintain the display of a real-time captured image in the preview component; a first display module configured to display a first element corresponding to the first image in a predetermined area of the capturing interface; and a second display module configured to, in response to capturing a second image displayed in the preview component using the capturing control, store the second image, and display at least a portion of the first element and at least a portion of a second element corresponding to the second image in the predetermined area of the capturing interface.

In a third aspect of the present disclosure, an electronic device is provided. The device includes: at least one processing unit; and at least one memory, coupled to the at least one processing unit and storing instructions executed by the at least one processing unit. The instructions, when executed by the at least one processing unit, cause the device to perform the method according to the first aspect of the present disclosure.

In a fourth aspect of the present disclosure, a computer readable storage medium is provided. The computer readable storage medium stores a computer program thereon. The computer program may be executed by a processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective embodiments of the present disclosure will become more apparent from the following detailed description with reference to the accompanying drawings. The same or similar reference numerals represent the same or similar elements throughout the figures, where:

FIG. 1 shows a schematic diagram of an example environment in which embodiments of the present disclosure can be implemented;

FIGS. 2A to 2H illustrate schematic diagrams of example interfaces according to some embodiments of the present disclosure;

FIG. 3 illustrates a flowchart of a process for image capturing according to some embodiments of the present disclosure;

FIG. 4 shows a schematic structural block diagram of an apparatus device for image capturing according to certain embodiments of the present disclosure; and

FIG. 5 illustrates a block diagram of an electronic device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure may be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be noted that the headings of any sections/subsections provided herein are not limiting. Various embodiments are described throughout this specification, and any type of embodiment may be included under any section/subsection. Furthermore, embodiments described in any section/subsection may be combined in any manner with any other embodiments described in the same section/subsection and/or different sections/subsections.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first”, “second” and the like may refer to different or identical objects. Other explicit and implicit definitions may also be included below.

The embodiments of the present disclosure may involve user data, the acquisition and/or use of data, etc. These aspects shall comply with corresponding laws and regulations and relevant provisions. In the embodiments of this disclosure, all the collection, acquisition, treatment, processing, forwarding and use of data are performed with the user's knowledge and confirmation. Accordingly, when implementing respective embodiments of the present disclosure, the user should be informed of the type, scope of use, and use scenario of the data or information involved in the present disclosure in an appropriate manner in accordance with relevant laws and regulations, and user authorization should be obtained. The specific notification and/or authorization methods may vary according to the actual situation and application scenarios, and the scope of the present disclosure is not limited in this regard.

In the solutions in this specification and embodiments, the processing of personal information, if involved, will be processed on the premise of legal basis (such as obtaining the consent of the personal information subject, or necessary to perform the contract, etc.), and will only be processed within the specified or agreed scope. The user's refusal to process personal information other than the necessary information required for basic functions will not affect the user's use of basic functions.

The embodiments of the present disclosure propose an image capturing solution. According to this solution, a capturing interface may be displayed, the capturing interface including a preview component and a capturing control; in response to capturing a first image displayed in the preview component using the capturing control, the first image is stored, and the display of a real-time captured image in the preview component is maintained; a first element corresponding to the first image is displayed in a predetermined area of the capturing interface; in response to capturing a second image displayed in the preview component using the capturing control, the second image is stored, and at least a portion of the first element and at least a portion of a second element corresponding to the second image are displayed in the predetermined area of the capturing interface.

Therefore, the embodiments of the present disclosure are capable of supporting users to achieve continuous image capturing through the capturing interface, and may provide users with previews of a plurality of images continuously captured in this round. In this way, the embodiments of the present disclosure may improve the efficiency of image capturing.

Example embodiments according to the present disclosure will be further described below with reference to the accompanying drawings.

### Example Environment

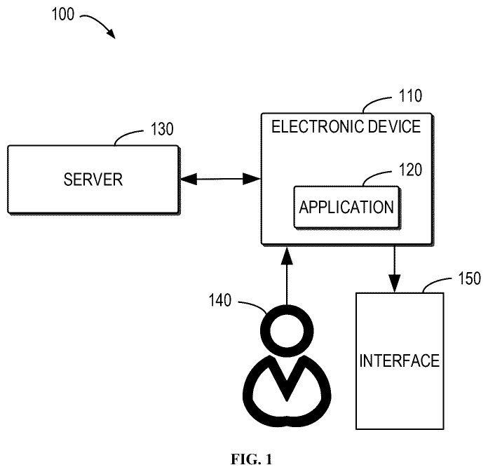

FIG. 1 shows a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include but are not limited to: camera applications, video applications, image applications, or other appropriate applications. A target user 140 may interact with the application 120 via the electronic device 110 and/or a device attached thereto.

In the environment 100 of FIG. 1, if the application 120 is active, the electronic device 110 may display an interface 150 for supporting interface interaction through the application 120.

In some embodiments, the electronic device 110 communicates with a server 130 to enable the provision of services to the application 120. The electronic device 110 may be any type of mobile terminal, fixed terminal or portable terminal, including mobile phone, desktop computer, laptop computer, notebook computer, netbook computer, tablet computer, media computer, multimedia tablet, palmtop computer, portable game terminal, VR/AR device, personal communication system (PCS) device, personal navigation device, personal digital assistant (PDA), audio/video player, digital camera/camcorder, positioning device, TV receiver, radio broadcast receiver, e-book device, gaming device, or any combination of the foregoing, including accessories and peripherals for these devices or any combination thereof. In some embodiments, the electronic device 110 may also support any type of interface for the target user (such as “wearable” circuitry, etc.).

The server 130 may be an independent physical server, or a server cluster or distributed system composed of multiple physical servers, or may further be a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the application 120 which supports interface interaction in the electronic device 110.

A communication connection may be established between the server 130 and the electronic device 110. Communication connections may be established in a wired or wireless manner. Communication connections may include but are not limited to Bluetooth connections, mobile network connections, universal serial bus (USB) connections, Wireless Fidelity (WiFi) connections, etc. The embodiments of the present disclosure are not limited in this regard. In the embodiments of the present disclosure, the server 130 and the electronic device 110 may implement signaling interaction through the communication connection between them.

It should be understood that the structure and function of various elements in the environment 100 are described for illustrative purposes only and do not imply any limitation on the scope of the present disclosure.

Some example embodiments of the present disclosure will be described below with reference to the accompanying drawings.

### Example Interaction

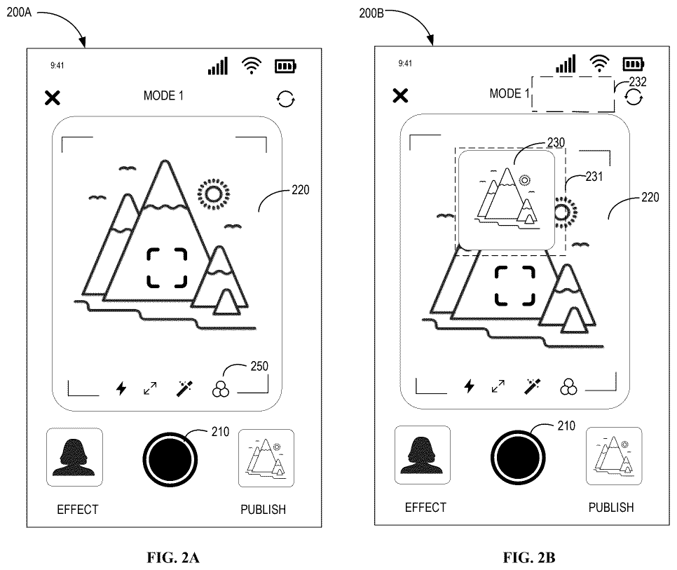

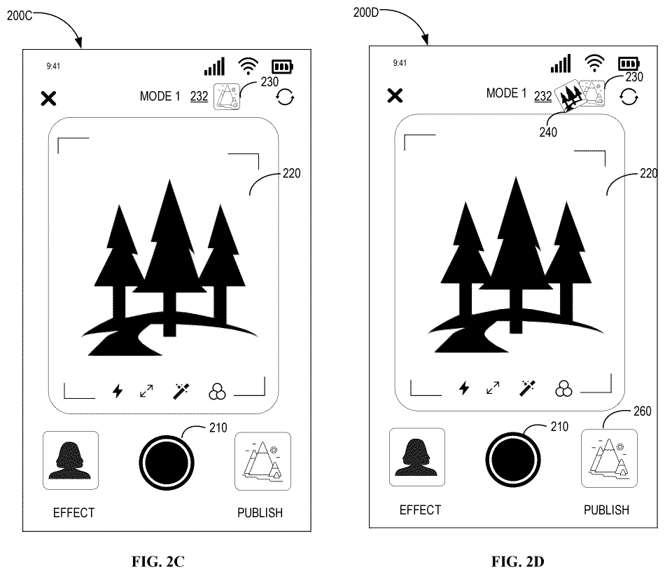

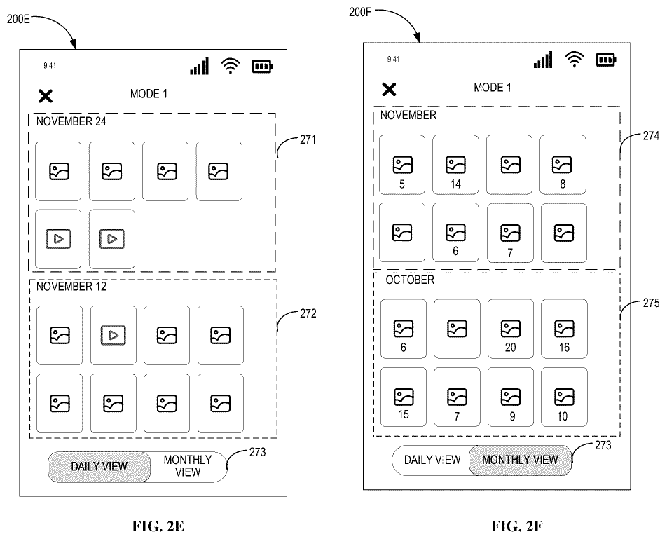

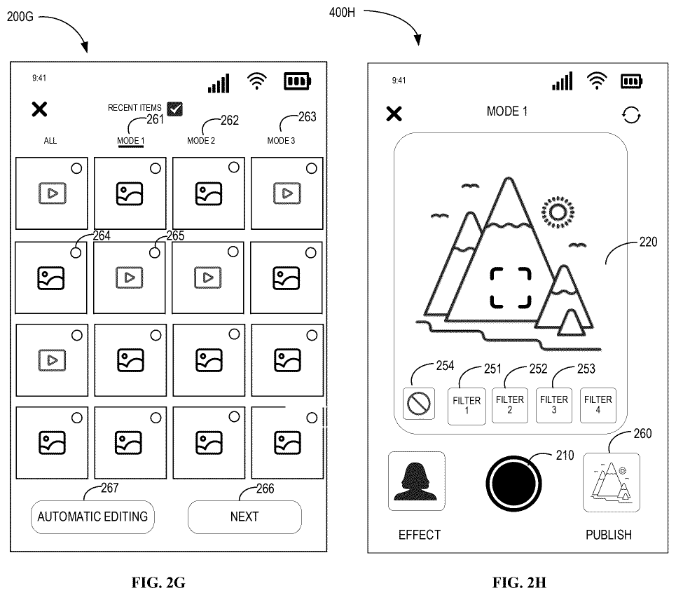

An example interaction process according to the embodiments of the present disclosure will be described below with reference to FIGS. 2A to 2H. These figures illustrate example interfaces 200A to 200H according to some embodiments of the present disclosure. The interfaces 200A to 200H may be provided, for example, by the electronic device 110 shown in FIG. 1.

As shown in FIG. 2A, the electronic device 110 may display a capturing interface 200A, for example. In some embodiments, the capturing interface 200A may be provided by the application 120 installed on the electronic device 110. For example, the electronic device 110 may present the capturing interface 200A as shown in FIG. 2A based on a capturing request of a user 140.

As shown in FIG. 2A, the interface 200A may include a capturing control 210 and a preview component 220. The preview component 220 may display a real-time image captured by a camera mounted on the electronic device 110.

In some embodiments, the electronic device 110 may capture an image based on the triggering of the capturing control 210 (e.g., click or long press) by the user. For example, after receiving a click on the capturing control 210, the electronic device 110 may capture an image displayed in the preview component 220 (also referred to as a first image). In some embodiments, images captured by the electronic device may include single pictures or video segments. In some embodiments, the electronic device may store the captured first image displayed in the preview component 220.

As shown in FIG. 2B, the electronic device 110 may, for example, display an element 230 corresponding to the captured first image in an area 231 in the preview component 220. As an example, such an element 230 may include, for example, a thumbnail of a captured picture or video.

In some embodiments, the electronic device 110 may move the element 230 into a predetermined area 232 in the interface 200B. As shown in FIG. 2C, after completing the capturing of the first image, the electronic device 110 may display the element 230 corresponding to the first image in the area 232, for example, a thumbnail of the first image.

Further, the electronic device 110 can maintain the displaying of a real-time captured image in the preview component 220 and support the user to continue capturing by triggering the capturing control 210.

For example, as shown in FIG. 2D, the electronic device 110 may receive the triggering of the capturing control 210 by the user to capture a second image displayed in the preview component 220. Such a second image may be, for example, a single photo or a video segment. In some embodiments, the electronic device may store the captured second image displayed in the preview component 220.

Similarly, the electronic device 110 may display an element 240 corresponding to the second image in the area 232 after completing the capturing of the second image. As an example, the element 240 may be, for example, a thumbnail of the captured second image.

Like the element 230, the electronic device 110 may, for example, first display the element 240 in the area 231 in the preview component 220, and further move the element 240 to the area 232 for display. During the movement of the element 230 or element 240, its dimensions may, for example, change adaptively.

In some embodiments, the first and second elements at least partially overlap. As an example, element 240 may, for example, cover part of the element 230.

In some embodiments, the display style of the elements 230 and 240 in the area 232 may be determined based on the number of elements displayed in the area 232. For example, as the number of images captured in this round increases, the display style of such elements may be changed accordingly, for example, to have a greater degree of overlap.

In this way, the embodiments of the present disclosure may support users to achieve continuous capturing of images through the capturing interface, and may display a plurality of images captured in this round through interface elements. The embodiments of the present disclosure may embed previews of a plurality of images in the application 120. Compared with only one image being previewed at a time and each image preview requiring the application 120 to interact once with the operating system of the electronic device 110, the present disclosure can effectively save resources required for interaction between the application 120 and the operating system of the electronic device 110. In addition, when publishing a work based on at least one image among a plurality of images, the present disclosure may preview the plurality of images at the same time, which may speed up the efficiency of selecting images required to publish the work and further improves the efficiency of publishing the work.

In some embodiments, the electronic device 110 may further present a viewing interface 200E as shown in FIG. 2E based on a predetermined operation received in a capturing interface 200D. As an example, the electronic device 110 may present the viewing interface 200E based on the user's selection of the predetermined area 232 or the element 230 or element 240 displayed in the predetermined area.

In some embodiments, after receiving a selection of a viewing portal 260, the electronic device 110 may display the viewing interface 200E as shown in FIG. 2E. As shown in FIG. 2E, the electronic device 110 may display a plurality of images captured using the above-mentioned capturing interface (e.g., the capturing interface under a continuous capturing mode) in the interface 200E. Such a plurality of images may include the first image and the second image as discussed above.

In some embodiments, the plurality of images may be displayed on a page of the electronic device according to different display modes. The display modes may include but are not limited to a day view mode and a month view mode. In the day view mode, the page of the electronic device may be divided into a plurality of areas on a daily basis. For each area, the area displays historical images captured on a certain day. In the month view mode, the page of the electronic device may be divided into a plurality of areas on a monthly basis. For each area, the area displays historical images captured in a certain month. Taking FIG. 2E as an example, in the day view mode, the interface 200E can display an area 271 and an area 272, and the area 271 displays historical images or historical videos captured using the continuous capturing mode on November 24, and the area 272 displays historical images or videos captured in the continuous capturing mode on November 12th.

Taking FIG. 2F as an example, in the day view mode, a page 200F displays an area 274 and an area 275, and the area 274 displays historical images or historical videos captured in the month of November, and the area 275 displays historical images or historical videos captured in the month of October.

In some embodiments, a switching control corresponding to the display mode may further be displayed on the interfaces 200E and 200F to support the user in selecting a display mode for a plurality of images. Taking FIG. 2E and FIG. 2F as examples, a switching control 273 corresponding to the display mode may be displayed in the interface 200E and the interface 200F. The user can click the switching control 273 to switch the display mode for a plurality of images.

In some embodiments, a plurality of images captured in this round (for example, the first image and the second image mentioned above) may be displayed in association in the viewing interface. For example, the electronic device 110 may present a plurality of images consecutively captured in this round with different background colors. Alternatively, the electronic device 110 may also present a plurality of images consecutively captured in this round in a separate list.

In some embodiments, the electronic device 110 receives the user's selection of at least one image among the plurality of images displayed by the viewing interface 200E or 200F, and may accordingly publish a work corresponding to the at least one image.

For example, after completing the capturing of a plurality of images in this round, the user can select one or more images from the plurality of images through the viewing interfaces 200E and 200F, and/or one or more images among historical images captured using the continuous capturing mode, and accordingly, enter a work editing interface. Further, the electronic device 110 may publish the corresponding work based on the selected at least one image.

In some further embodiments, after receiving the selection of the portal 260 in the capturing interface 200D as shown in FIG. 2D, the electronic device 110 may display a viewing interface 200G as shown in FIG. 2G. For example, the viewing interface 200G may display a plurality of images captured using different capturing modes.

For example, the capturing interfaces 200A-200D as discussed above may correspond to a first capturing mode (e.g., mode 261). In some embodiments, the viewing interface 200G may also display one or more sets of images captured in other capturing modes (e.g., mode 262 and mode 263).

In some embodiments, an interface 200H may also provide a publishing control 266 for publishing works. For example, the electronic device 110 can receive the user's selection of an image 264 and an image 265, and enter the editing or publishing interface of the corresponding work based on the triggering of the control 266.

Additionally, the electronic device 110 may also provide a control 267 for automatic editing to support the electronic device to automatically edit the work based on the image selected by the user.

In this way, the embodiments of the present disclosure may support users, after completing the continuous capturing of images, to select images that meet the requirements through image selection, so as to publish works.

In some embodiments, an effect control 250 may also be provided in the interface 200A to support image effects corresponding to the application. As an example, after the user selects the effect control 250, the electronic device may display the page 200G shown in FIG. 2G.

As shown in FIG. 2G, the electronic device 110 may display a set of candidate effects, such as a filter effect 251, a filter effect 252, a filter effect 253, etc., and a blank effect 254 in the preview component 220.

Further, the electronic device 110 may receive the user's selection of a target filter in the filter effects 251 to 253 and apply the target filter to the real-time image captured by the preview component 220.

Thus, the embodiments of the present disclosure may further facilitate users to apply desired image effects.

### Example Process

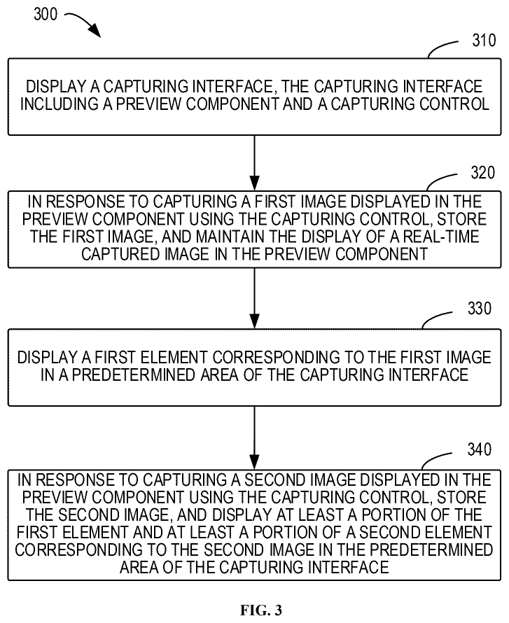

FIG. 3 illustrates a flowchart of an example process 300 of image capturing according to some embodiments of the present disclosure. The process 300 may be implemented at the electronic device 110. The Process 300 is described below with reference to FIG. 1.

As depicted, at block 310, the electronic device 110 displays a capturing interface, the capturing interface including a preview component and a capturing control.

At block 320, the electronic device 110, in response to capturing a first image displayed in the preview component using the capturing control, stores the first image, and maintains the display of a real-time captured image in the preview component.

At block 330, the electronic device 110 displays a first element corresponding to the first image in a predetermined area of the capturing interface.

At block 340, the electronic device 110, in response to capturing a second image displayed in the preview component using the capturing control, the second image is stored, and at least a portion of the first element and at least a portion of a second element corresponding to the second image are displayed in the predetermined area of the capturing interface.

In some embodiments, the capturing interface is provided by a target application. The process 300 further includes: displaying a viewing interface based on a predetermined operation received in the capturing interface; and displaying, in the viewing interface, a plurality of images captured using the capturing interface of the target application, the plurality of images including at least the first image and the second image.

In some embodiments, the first image and the second image are displayed in association in the viewing interface.

In some embodiments, the process 300 further includes: receiving a selection of at least one image of the plurality of images; and publishing a work corresponding to the at least one image.

In some embodiments, the predetermined operation includes: selection of the predetermined area; or selection of the first element or the second element displayed in the predetermined area.

In some embodiments, the capturing interface corresponds to a first capturing mode, and the viewing interface further displays a set of images captured through a second capturing mode.

In some embodiments, displaying the first element corresponding to the first image in the predetermined area of the capturing interface includes: in response to capturing the first image displayed in the preview component using the capturing control, displaying the first element corresponding to the first image in the preview component; and moving the first element from the preview component to the predetermined area.

In some embodiments, displaying at least a portion of the first element and at least a portion of the second element corresponding to the second image in the predetermined area of the capturing interface includes: in response to capturing the second image displayed in the preview component using the capturing control, displaying the second element corresponding to the second image in the preview component; and moving the second element from the preview component to the predetermined area.

In some embodiments, the first and second elements at least partially overlap.

In some embodiments, the display style of the first element and the second element in the predetermined area is determined based on the number of elements displayed in the predetermined area.

In some embodiments, the capturing interface further includes an effect control, and the process 300 further includes: displaying a set of candidate effects in the preview component based on the selection of the effect control; and applying a target effect to a real-time captured image in the preview component based on the selection of the target effect in the set of candidate effects.

### Example Apparatus and Device

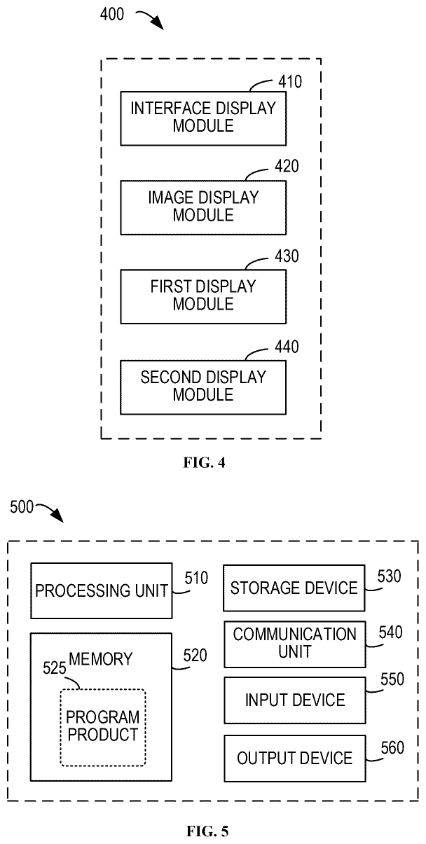

The embodiments of the present disclosure further provide a corresponding apparatus for implementing the above method or process. FIG. 4 illustrates a schematic structural block diagram of an example apparatus 400 for image capturing according to certain embodiments of the present disclosure. The apparatus 400 may be implemented as or included in the electronic device 110. Respective modules/components in the apparatus 400 may be implemented by hardware, software, firmware, or any combination thereof.

As shown in FIG. 400, the apparatus 400 includes: an interface display module 410 configured to display a capturing interface, the capturing interface including a preview component and a capturing control; an image display module 420 configured to, in response to capturing a first image displayed in the preview component using the capturing control, store the first image, and maintain the display of a real-time captured image in the preview component; a first display module 430 configured to display a first element corresponding to the first image in a predetermined area of the capturing interface; and a second display module 440 configured to, in response to capturing a second image displayed in the preview component using the capturing control, store the second image, and display at least a portion of the first element and at least a portion of a second element corresponding to the second image in the predetermined area of the capturing interface.

In some embodiments, the capturing interface is provided by a target application. The apparatus 400 further includes: a first processing module configured to display a viewing interface based on a predetermined operation received in the capturing interface; and display, in the viewing interface, a plurality of images captured using the capturing interface of the target application, the plurality of images including at least the first image and the second image.

In some embodiments, the first image and the second image are displayed in association in the viewing interface.

In some embodiments, the apparatus 400 further includes: a second processing module configured to receive a selection of at least one image of the plurality of images; and publish a work corresponding to the at least one image.

In some embodiments, the predetermined operation includes: selection of the predetermined area; or selection of the first element or the second element displayed in the predetermined area.

In some embodiments, the capturing interface corresponds to a first capturing mode, and the viewing interface further displays a set of images captured through a second capturing mode.

In some embodiments, displaying the first element corresponding to the first image in the predetermined area of the capturing interface includes: in response to capturing the first image displayed in the preview component using the capturing control, displaying the first element corresponding to the first image in the preview component; and moving the first element from the preview component to the predetermined area.

In some embodiments, the second display module 440 is specifically configured to: in response to capturing the second image displayed in the preview component using the capturing control, display the second element corresponding to the second image in the preview component; and move the second element from the preview component to the predetermined area.

In some embodiments, the first and second elements at least partially overlap.

In some embodiments, the display style of the first element and the second element in the predetermined area is determined based on the number of elements displayed in the predetermined area.

In some embodiments, the capturing interface further includes an effect control, and the apparatus 400 further includes: a third processing module configured to display a set of candidate effects in the preview component based on the selection of the effect control; and apply a target effect to a real-time image captured in the preview component based on the selection of the target effect in the set of candidate effects.

The modules included in the apparatus 400 may be implemented in various ways, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example, and not limitation, example types of hardware logic components which may be used include field programmable gate arrays (FPGAs), application specific integrated circuits (ASICs), application specific standard products (ASSPs), systems on a chip (SOCs), complex programmable logic devices (CPLD), etc.

FIG. 5 shows a block diagram of an electronic device 500 that may implement one or more embodiments of the present disclosure. It should be understood that the electronic device 500 shown in FIG. 5 is merely example and should not constitute any limitation on the functionality and scope of the embodiments described herein. The electronic device 500 shown in FIG. 5 may be used to implement the electronic device 110 in FIG. 1.

As shown in FIG. 5, the electronic device 500 is in the form of a general purpose computing device. Components of the electronic device 500 may include, but are not limited to, one or more processors or processing units 510, a memory 520, a storage device 530, one or more communication units 540, one or more input devices 1550, and one or more output devices 560. The processing unit 510 may be a physical or virtual processor and may execute various processing based on the programs stored in the memory 520. In a multi-processor system, a plurality of processing units executes computer-executable instructions in parallel to enhance parallel processing capability of the electronic device 500.

The electronic device 500 usually includes a plurality of computer storage mediums. Such mediums may be any attainable medium accessible by the electronic device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the electronic device 500.

The electronic device 500 may further include additional removable/non-removable, volatile/non-volatile storage mediums. Although not shown in FIG. 5, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various embodiments of the present disclosure.

The communication unit 540 implements communication with another computing device via a communication medium. Additionally, functions of components of the electronic device 500 may be realized by a single computing cluster or a plurality of computing machines, and these computing machines may communicate through communication connections. Therefore, the electronic device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the electronic device 500, or with any device (such as a network card, a modem, and the like) that enable the electronic device 500 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method for image capturing, comprising:
displaying a capturing interface, the capturing interface comprising a preview component and a capturing control;
in response to capturing a first image displayed in the preview component using the capturing control, storing the first image, and maintaining the display of a real-time captured image in the preview component;
displaying a first element corresponding to the first image in a predetermined area of the capturing interface; and
in response to capturing a second image displayed in the preview component using the capturing control, storing the second image, and displaying at least a portion of the first element and at least a portion of a second element corresponding to the second image in the predetermined area of the capturing interface.

2. The method of claim 1, wherein the capturing interface is provided by a target application, and the method further comprises:
displaying a viewing interface based on a predetermined operation received in the capturing interface; and
displaying, in the viewing interface, a plurality of images captured using the capturing interface of the target application, the plurality of images comprising at least the first image and the second image.

3. The method of claim 2, wherein the first image and the second image are displayed in association in the viewing interface.

4. The method of claim 2, further comprising:
receiving a selection of at least one image of the plurality of images; and
publishing a work corresponding to the at least one image.

5. The method of claim 2, wherein the predetermined operation comprises:
selection of the predetermined area; or
selection of the first element or the second element displayed in the predetermined area.

6. The method of claim 2, wherein the capturing interface corresponds to a first capturing mode, and the viewing interface further displays a set of images captured through a second capturing mode.

7. The method of claim 1, wherein displaying the first element corresponding to the first image in the predetermined area of the capturing interface comprises:
in response to capturing the first image displayed in the preview component using the capturing control, displaying the first element corresponding to the first image in the preview component; and
moving the first element from the preview component to the predetermined area.

8. The method of claim 1, wherein displaying at least a portion of the first element and at least a portion of the second element corresponding to the second image in the predetermined area of the capturing interface comprises:
in response to capturing the second image displayed in the preview component using the capturing control, displaying the second element corresponding to the second image in the preview component; and
moving the second element from the preview component to the predetermined area.

9. The method of claim 1, wherein the first element and the second element at least partially overlap.

10. The method of claim 1, wherein the display style of the first element and the second element in the predetermined area is determined based on the number of elements displayed in the predetermined area.

11. The method of claim 1, wherein the capturing interface further comprises an effect control, and the method further comprises:
displaying a set of candidate effects in the preview component based on a selection of the effect control; and
applying a target effect to the real-time captured image in the preview component based on the selection of the target effect in the set of candidate effects.

12. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
displaying a capturing interface, the capturing interface comprising a preview component and a capturing control;
in response to capturing a first image displayed in the preview component using the capturing control, storing the first image, and maintaining the display of a real-time captured image in the preview component;
displaying a first element corresponding to the first image in a predetermined area of the capturing interface; and
in response to capturing a second image displayed in the preview component using the capturing control, storing the second image, and displaying at least a portion of the first element and at least a portion of a second element corresponding to the second image in the predetermined area of the capturing interface.

13. The electronic device of claim 12, wherein the capturing interface is provided by a target application, and the acts further comprise:
displaying a viewing interface based on a predetermined operation received in the capturing interface; and
displaying, in the viewing interface, a plurality of images captured using the capturing interface of the target application, the plurality of images comprising at least the first image and the second image.

14. The electronic device of claim 13, wherein the first image and the second image are displayed in association in the viewing interface.

15. The electronic device of claim 13, the acts further comprising:
receiving a selection of at least one image of the plurality of images; and
publishing a work corresponding to the at least one image.

16. The electronic device of claim 13, wherein the predetermined operation comprises:
selection of the predetermined area; or
selection of the first element or the second element displayed in the predetermined area.

17. The electronic device of claim 13, wherein the capturing interface corresponds to a first capturing mode, and the viewing interface further displays a set of images captured through a second capturing mode.

18. The electronic device of claim 12, wherein displaying the first element corresponding to the first image in the predetermined area of the capturing interface comprises:
in response to capturing the first image displayed in the preview component using the capturing control, displaying the first element corresponding to the first image in the preview component; and
moving the first element from the preview component to the predetermined area.

19. The electronic device of claim 12, wherein displaying at least a portion of the first element and at least a portion of the second element corresponding to the second image in the predetermined area of the capturing interface comprises:
in response to capturing the second image displayed in the preview component using the capturing control, displaying the second element corresponding to the second image in the preview component; and
moving the second element from the preview component to the predetermined area.

20. A non-transitory computer-readable storage medium having a computer program stored thereon, wherein the computer program, when executed by a processor, implements a method for image capturing, comprising:
displaying a capturing interface, the capturing interface comprising a preview component and a capturing control;
in response to capturing a first image displayed in the preview component using the capturing control, storing the first image, and maintaining the display of a real-time captured image in the preview component;
displaying a first element corresponding to the first image in a predetermined area of the capturing interface; and
in response to capturing a second image displayed in the preview component using the capturing control, storing the second image, and displaying at least a portion of the first element and at least a portion of a second element corresponding to the second image in the predetermined area of the capturing interface.
